(19) United States
(12) Patent Application Publication
(10) Pub. No.: US 2013/0328696 A1
(43) Pub. Date: Dec. 12, 2013

(54) PASSIVE REDIRECTION DEVICE FOR CONSUMPTION METER COMMUNICATION

(71) Applicant: Jens Drachmann, Viby J (DK)

(72) Inventor: Jens Drachmann, Viby J (DK)

(21) Appl. No.: 14/001,526

(22) PCT Filed: Feb. 21, 2012
(86) PCT No.: PCT/DK2012/000016

§ 371 Date: Aug. 26, 2013

(30) Foreign Application Priority Data
Feb. 24, 2011 (DK) PA 2011 00130

(51) Int. Cl. G01D 4/00

(52) U.S. Cl. CPC G01D 4/002
USPC 340/870.02

(57) ABSTRACT

A method of transmitting and redirecting a radio signal using a data transmission system, the data transmission system including a data collection unit, a radio transmitter being connected to the data collection unit, and a redirection device being arranged at the top of a hollow shaft, the radio transmitter and the data collection unit being arranged in a lower part of the hollow shaft, the method including the steps of the radio transmitter transmitting the radio signal representative of measurement data from the data collection unit, and the redirection device redirecting the radio signal to be received at a communication device. The invention furthermore relates to a data transmission system and a redirection device adapted for operating in accordance with the above mentioned method.

### TECHNICAL FIELD

The present invention relates to redirection device for redirection a radio wave signal from a data acquisition device, such as a utility meter, to a communication device and a method for transmitting and redirecting said radio signal by means of said redirection device.

### BACKGROUND OF THE INVENTION

Consumption meters communicating by the emission of modulated electromagnetic waves at radio frequencies is a well-known technology for reading the status of such meters. The method allows remote reading in several different topologies, and a very long communication range is often feasible, depending on the parameters of the system. The parameters influencing the range are, among others: transmission frequency, bit transmission rate, message length, modulation scheme, error correction, antenna size, antenna directivity, transmission power, receiver noise level, receiver selectivity, interference from other sources, and finally reflections and absorption from structures between the consumption meter and the communication device adapted to communicate with the meter.

In some situations the communication range may be insufficient for the application to operate reliably. Most often this is the case, when the meter is placed in non-optimal positions such as a pit in the ground, a cellar, or in other positions where the communication range is limited by structures between the meter and the communication device.

Several solutions to this challenge have been proposed in the patent literature. EP2187174 suggests mounting a repeater on top of the lid on a meter pit, so that radio transmission signals are retransmitted in directions more suitable. Although this solution increases the range considerably, it has the drawback that it is a complex, expensive, and energy consuming solution.

Other solutions such as US2008106434, US2005285807 and US2001011009 suggest mounting a repeater either below or inside the lid on a meter pit. These solutions protect the sensitive electronic circuitry to some degree, but the mounting of the repeater is complicated, and the antenna position is less optimal. In addition the lifetime of the repeater in these solutions is limited due to the embedded battery power source. These solutions have the drawbacks that they are complex and expensive, energy consuming, and have limited lifetimes.

Thus, it is an objective of the invention to solve one or more of the above problem.

### BRIEF DESCRIPTION

It is an object of this invention to provide a low-cost, robust, and easy to mount device that aids radio communication from a utility meter placed in a non-optimal position.

The invention relates to a method of transmitting and redirecting a radio signal by means of a data transmission system,

said data transmission system comprising
a data collection unit,
a radio transmitter being connected to said data collection unit, and
a passive redirection device being arranged at the top of a hollow shaft, said radio transmitter and said data collection unit being arranged in a lower part of said hollow shaft,

said method comprising the steps of
said radio transmitter transmitting said radio signal representative of measurement data from said data collection unit, and
said redirection device redirecting said radio signal to be received at a communication device.

By redirecting radio waves is meant changing the direction of propagation of radio waves. This change of direction is preferably from a more vertical direction to a more horizontal direction, i.e. making the direction of propagation more horizontal. Thereby, distant communication stations for picking up measurements may receive and detect signals for which the signal strength was too low for the more vertical direction of propagation. According to an example embodiment, the redirection corresponds to changing the direction of propagation of the radio waves by approximately 90° (degrees), such as, 80°-100°, or alternatively by 30°-40°, 40°-50°, 50°-60°, 60°-70°, 70°-80°, 80°-90°, 90°-100°, 100°-110°, or by 110°-120°. This changing the direction may be a uniform change in at least substantially the same direction for at least a large part of the radio waves by reflection, or it may be an average change of direction in at least partly different directions, preferably in a more horizontal direction, due to refraction, diffraction, scattering or other processes changing the direction or propagation of the radio waves. By a passive redirection device is meant an electrically passive redirection device. I.e. the redirection device redirects the radio waves rather than e.g. repeating the radio signal.

Various mechanisms of such redirection exist. One example of redirection may be by reflection on a reflective surface or by another reflective material. Another example of redirection may be by a lens or other at least partly transparent material, which refracts, diverges, or converges the radio waves. The above examples may be combined, i.e. a material that is at least partly transparent may also reflect, and furthermore a reflective surface may also have a diverging or converging effect on the reflected radio waves.

A communication device is to be understood as a unit for receiving a radio signal, preferably a remote communication device. It may preferably be ground based, i.e. it is connected to the ground. Examples of such may e.g. be antennas mounted in buildings, towers, masts, or towers, or antennas placed directly on the ground. I.e. ground based is to be understood as opposite to satellites or antennas mounted on air-borne structures such as aircrafts. By remote is meant distant, such as e.g. 0.5 kilometers away, 2 kilometers away, 5 kilometers away, or more than 10 kilometers away. However, the communication device may alternatively be placed in proximity or at least relative proximity, such as e.g. 100-500 meters, 50-100 meters, 10-50 meters, or even 2-10 meters.

At the top may means in the upper part, near the lid, in connection with the lid, in the lid, or on or right above the lid.

One advantage of the above embodiment is that by redirecting the radio waves into a more horizontal direction, the communication range with ground based external communication units is increased. Thereby, it is possible to operate a data collection units spread over a larger area using the same external communication unit. An advantage of the redirection device being passive, is that is does not use any electrical power. Thereby, disadvantages of changing batteries or supplying the device with power from an external power source are avoided. A further advantage of the redirection device being electrically passive is that it is a simple and durable redirection device.

In an embodiment of the invention, the device disclosed redirects radio transmission signals between one or more utility meters and one more communication devices, so that an increase in the communication range is achieved. In the preferred embodiment, the device is a passive structure adapted to have a mirror or lens effect, so that radio waves propagating towards the device is reflected, converged, or diverged in preferred directions.

In one advantageous embodiment of the invention, said radio transmitter comprises a radio wave emitter adapted for emitting radio waves.

By a radio wave emitter is meant an apparatus adapted for emitting radio waves, i.e. for transmitting or emitting electromagnetic radiation in the radio frequency band. A radio interface is to be understood as a radio transmitter comprising a radio wave emitter, i.e. an interface for communicating with radio waves. A radio signal is to be understood as a radio wave signal, i.e. a signal of electromagnetic radiation in the radio frequency band. The radio frequency band is frequencies suitable for wireless communication. Such frequencies may e.g. be between 3 kHz (kilohertz) and 300 GHz (gigahertz).

According to one advantageous embodiment of the invention said data collection unit is a utility meter.

By a utility meter is meant a measuring apparatus or a meter for measuring on a utility system. Such a utility meter preferably measures at least the consumption of a utility, such as water, gas, electricity, heat or other utilities, measured on a utility system, which the utility meter is connected.

Alternatively or additionally, the utility meter may measure at least one parameter on a utility system to which it is connected, such parameter may e.g. be a temperature, a pH-value, a humidity value, or other environmental values.

Because utility meters may be positioned in locations, where most of the radio signals transmitted from such utility meters are absorbed in the surrounding, e.g. in the ground for utility meter in underground meter pits, and in the building material for utility meters positioned in utility shafts. Furthermore, the part of the radio signal that is not absorbed, often have a disadvantageous direction of propagation, such as vertically upwards. Therefore such radio signals are hard to detect by distant ground based communication devices. An advantage of the above embodiment is therefore that by implementing a redirection device according to the invention for utility meters, the part of the radio signal that is not absorbed, is redirected into a more advantageous direction, such as more horizontally, thereby increasing the effective communication range of the utility meters. This means that the same number of utility meters distributed over a certain area may be operated by fewer communication devices.

According to one advantageous embodiment of the invention, said measurement data comprises measured consumption data.

The redirection device is particularly advantageous for utility meters measuring consumption data, i.e. which measures the consumption of e.g. water, heat, electricity, gas, or other utilities, as such utility meters may often be positioned such that it is difficult to transmit a radio signal to a communication device of a remote readout station.

According to one advantageous embodiment of the invention said hollow shaft is a meter pit.

By a meter pit is meant an underground pit in which a meter is installed. Such meters may typically be utility meters connected to a utility grid and measuring the consumption of the utility of the utility grid, such as water, heat, gas, electricity or other utilities.

According to one advantageous embodiment of the invention said hollow shaft is a utility shaft.

By a utility shaft is meant a shaft in a building or construction, which allows utilities to be distributed. Utility meters may therefore typically be placed in such shafts. However, since the rest of the building or construction absorbs emitted radio waves from such utility meters, it may be difficult to perform remote readout of such utility meters. However, by incorporating the redirection device according to this aspect of the invention, the radio waves may be effectively emitted from the building and transmitted to a remote readout station.

According to another advantageous embodiment of the invention, said method furthermore comprises the step of
said radio transmitter receiving measurement data from said data collection unit.

The measurements data from the data collection unit is preferably sent to the radio transmitter, which then transmits the measurement data as a radio wave signal.

According to another advantageous embodiment of the invention, said data collection unit and said redirection device are separated by a distance corresponding to at least half the vertical distance of said hollow shaft.

Typically the data collection unit, such as a utility meter, may be placed near the bottom of the hollow shaft, such as the meter pit. Furthermore, to effectively redirect the radio waves, the redirection device is preferably placed near the top of the hollow shaft. This may be in the hollow shaft itself, i.e. below the lid, or it may be connected to or incorporated or embedded in the lid itself, or alternatively it may be on top of the lid. By positioning the redirection device inside the hollow shaft, it may be protected from the outside climate and weather conditions. The distance between the redirection device and the data collection unit may in alternative embodiments be at least 60% of the height of the hollow shaft, or alternatively at least 70% or at least 80% of the height of the hollow shaft.

According to another advantageous embodiment of the invention, said radio transmitter is integrated in data collection unit.

An advantage of the above described aspect is that said radio transmitter and said data collection unit may be protected against environmental hazards. Thereby, the data collection unit comprising the radio transmitter may be enclosed in a single protective casing or container. If the radio transmitter is arranged external from said data collection unit, two different casings or containers must be used in order to protect both. Furthermore, radio transmitter and the data collection unit must be connected in order to transfer data from the data collection unit to the radio transmitter. Such connection may be a wired transmission or a wireless transmission. For wired transmissions, the two protective casings or containers must each be provided with insertion holes allowing the wire access to the interior of the protective casing or container. Thereby, the protection provided by said protective casing or container may easily be weakened. If the connection is a wireless connection, the data collection unit and the radio transmitter must both be provided with wireless communication modules. Therefore, a data collection unit comprising a radio transmitter according to the above aspect, where the two may be connected by wire while being encapsulated in the same protective casing or container, is highly advantageous. Such an advantageous stand-alone unit has not external power supply, thereby eliminating the potential leak of a power line.

According to another advantageous embodiment of the invention, said redirection device comprises a metal cylinder.

Such a metal cylinder may be attached to the lid of the hollow shaft or meter pit. Thereby, it can easily be removed together with the lid. Also, metal cylinder is preferably connectable to various lids, thereby making installation on existing lid and/or meter pits easier. The metal cylinder may e.g. be a metal foil, such as an aluminum foil or other metal foils. Such a foil may preferably have a thickness between 0.01 millimeter and 0.7 millimeter. Alternatively, thicker metal cylinders may be used, such as metal cylinders with thickness between 0.5 millimeter to 2 millimeters, or between 1 millimeter and 1 centimeter, or even thicker cylinders of 1 centimeter to 10 centimeters. The height of the metal cylinder may in an example embodiment e.g. be 30 centimeters, but in alternative embodiments be smaller, such as between 10 centimeters and 30 centimeters, or larger, such as 30 centimeters to 50 centimeters or 50 centimeters to 1 meter. The above solution is particularly advantageous for communication with frequencies near 868 MHz, but may also be advantageous when using other frequencies.

According to yet another advantageous embodiment of the invention, said redirection device comprises one or more metallic plates.

One advantage of the above embodiment is that by redirecting the radio waves by said metallic plates, a uniform redirection is achieved. I.e. all or at least a large fraction of the radio waves is redirected in at least substantially the same direction. This embodiment is particularly advantageous for redirection radio waves to one specific remote communication device for readout of the data of the data collection unit.

In one embodiment, the device is a metallic plate located near the meter, so that radio waves emitted by the meter are reflected in a new direction. A reflector of this kind is typically larger than one wavelength across to be effective. Using such a device will allow communication with meters placed in positions such as shafts, wells, and pits, if the plate is placed in such a way, that it reflects the radio waves between the meter and the communication device.

According to another advantageous embodiment of the invention, said one or more metallic plates of said redirection device have at least one length that is longer than the wavelength of the radio transmission signals.

One advantage of the above embodiment is that such a redirection device reflects a particularly high degree of the incident radio waves.

According to another advantageous embodiment of the invention, said redirection device comprises of one or more metallic meshes.

One advantage of the above embodiment is that the redirection device is less affected by wind conditions. Another advantage is that the redirection device may be manufactured using a minimum of material.

Due to the properties of the radio waves, the metallic plate does not need to be completed over the whole area. A fine metallic mesh will reflect the waves effectively if the meshes are smaller than the wavelength of the waves, such as less than 1/10 of a wavelength. This is advantageous because it decreases the weight of the plate, and decreases the wind load on the plate if it is placed in a windy position.

According to another advantageous embodiment of the invention, said one or more metallic plates of said redirection device are curved.

An advantage of the above embodiment is that the radio waves are focused by the curved plates. Thereby a coherent radio wave beam may be sustained over a longer distance, thereby minimized spreading of the radio wave signal.

In another embodiment the device is a curved metallic plate that focuses radio waves, so that the natural spreading of the radio waves emitted from a utility meter is minimized once the waves have been reflected on the plate. Such an approach will allow very long communication ranges, if the focused radio wave is directed toward the communication device. This implementation is especially beneficial for redirecting radio signals from meters placed in a utility shaft in a tall building. Such meters can be very difficult to reach by radio communication, but placing a focused reflector on top of the shaft so that the radio waves are directed towards a communication device increases the communication range considerably.

In one embodiment of the invention, the redirection device comprises at least one curved metal mesh. This embodiment combines the advantages of using metal meshes with the advantages of using curved metal plates.

According to another advantageous embodiment of the invention, said redirection device comprises one or more Fresnel lenses.

Other types of embodiments based on the same invention uses one or more Fresnel lenses or one or more lenses made of one or more meta-materials with negative refraction index. Such lenses enable manufacturing of lenses with less use of material and a more optimal form factor.

An advantage of the above embodiment is that a redirection device with a smaller weight and material use may be used.

According to another advantageous embodiment of the invention, said redirection device comprises one or more components made of a metamaterial. This may in an example embodiment be e.g. a material with a negative refractive index.

According to another advantageous embodiment of the invention, said redirection device comprises one or more dielectric lenses.

In yet another embodiment, the device is implemented as a dielectric lens directing the radio waves in one or more beneficial directions. This implementation is especially beneficial for meters positioned in meter pits below ground. In this situation, most of the radio energy emitted from the meter is absorbed by the ground, and the remaining is radiated upwards. This severely limits the communication range towards communication devices placed anywhere else but directly above the pit. By placing a dielectric lens on top of the meter pit, the radio waves are spread, so that the resulting radio waves send more energy towards the horizon. In this way, the communication range is increased in directions more typical for communication devices positions. An example of a dielectric lens for electromagnetic wave beam broadening in another context may e.g. be found in the American patent U.S. Pat. No. 4,636,798.

An advantageous material for a dielectric lens for meter pit purposes is a polymeric material reinforced with glass fibers. This creates a strong and durable device with a high relative permittivity, thus an effective lens. Silicon rubber is another useful material for this purpose, but it needs some kind of protection due to lower mechanical strength.

In an advantageous embodiment, the shape of the dielectric lens is a half torus shaped. An example of such may be found in the American patent U.S. Pat. No. 4,636,798. A preferred implementation includes a cover, so that the device can be placed on a lid for a meter pit. An example of such cover may e.g. be found in European patent application EP2187174. The cover hides the hole in the middle of the half torus, so that the device is easier to pass for pedestrians. In another embodiment, the dielectric lens is embedded into the pit lid. This has the advantage that the device is invisible from above, and the combined product is easier to handle than a separate lid and a device.

In an especially advantageous embodiment, the dielectric lens is built into the lid as concentric cylinders of different lengths, so that the thickness of the material is substantially constant. This is especially important for certain manufacturing processes, such as injection molding.

The invention furthermore relates a data transmission system for transmitting and redirecting a radio signal,

said data transmission system comprising
a data collection unit,
a radio transmitter being connected to said data collection unit, and
a passive redirection device being arranged at the top of a hollow shaft,

said radio transmitter and said data collection unit being arranged in a lower part of said hollow shaft,

wherein said radio transmitter is being configured for during operation and transmitting said radio signal representative of measurement data from said data collection unit, and

wherein said redirection device is being arranged for redirecting said radio signal to be received at a communication device.

The data transmission system for transmitting and redirecting a radio signal may be combined with any aspect of the application. The communication device may preferably be a remote communication device.

The invention furthermore relates to a redirection device for redirecting a radio signal from a radio transmitter, wherein said redirection device, when positioned at the top of a hollow shaft, is being adapted for redirecting a radio signal from said radio transmitter positioned in a lower part of said hollow shaft.

The device for redirecting a radio signal from a radio transmitter may be combined with any aspect of the application.

### BRIEF DESCRIPTION OF THE DRAWING

An embodiment of the present invention will in the following be described with reference to the drawings in which

FIG. 1 illustrates a meter without a redirection device,

FIG. 2 illustrates a meter, a redirection device, and a communication device according to an embodiment of the invention,

FIG. 3 illustrates a meter and a redirection device comprising dielectric lenses according to an embodiment of the invention,

FIG. 4 illustrates a meter and a redirection device comprising dielectric lenses according to an embodiment of the invention,

FIG. 5 illustrates a meter in a building and a redirection device according to an embodiment of the invention,

FIG. 6 illustrates a redirection device comprising a metallic grid according to an embodiment of the invention,

FIG. 7 illustrates a redirection device comprising a metallic mesh according to an embodiment of the invention,

FIG. 8 illustrates a redirection device comprising a curved metallic plate according to an embodiment of the invention,

FIG. 9 illustrates a redirection device comprising a Fresnel lens according to an embodiment of the invention,

FIG. 11 illustrates meter and a redirection device comprising a metal cylinder according to an embodiment of the invention, and

FIG. 10 illustrates a redirection device comprising a metal cylinder according to an embodiment of the invention.

### DETAILED DESCRIPTION OF THE INVENTION

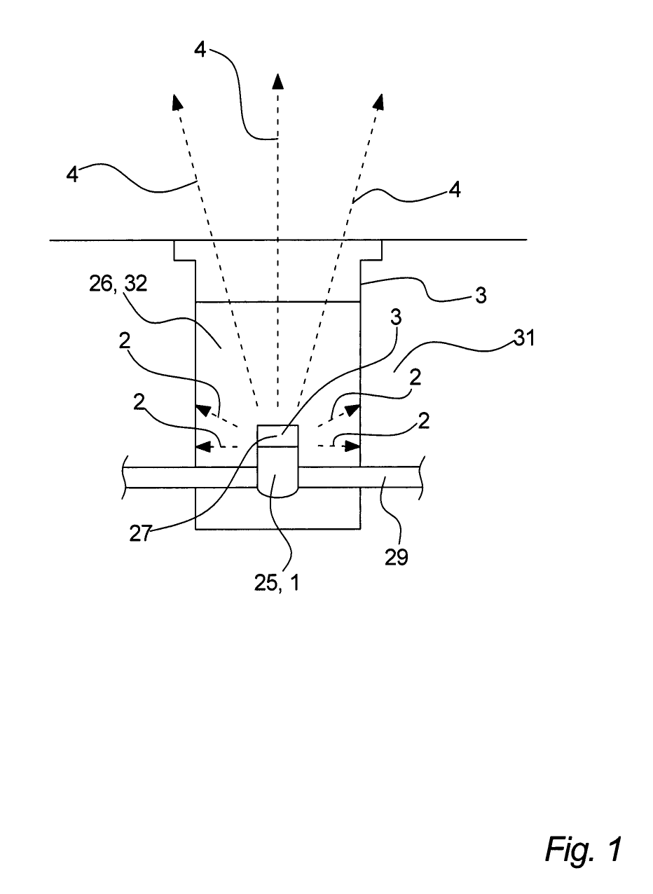

Referring to FIG. 1, a data collection unit 25, such as a utility meter 1, is situated in a hollow shaft 26, such as a meter pit 32, is illustrated. As it can be seen from FIG. 1, the data collection unit 25 is positioned in the lower part of the hollow shaft 26. The data collection unit 25 comprises a radio transmitter or radio emitter 27. The hollow shaft 26 may e.g. be a meter pit 32 or a utility shaft 12. Furthermore such a data collection unit 25 may be connected to a part of a utility system 29. The hollow shaft 26 may be comprise a upper end closing part 30, which seals off the hollow shaft 26 from the surroundings. The data collection unit 25 may collect data from the part of the utility system 29, which it is connected to. Such collected data may e.g. be data representing consumption of e.g. gas, water, heat provided by the utility system. As it is illustrated on FIG. 1, the radio emitter 27 emits a radio signal in the form of radio waves 2, 4. While some radio waves 2 are absorbed or attenuated in the solid surroundings 10 of the ground 38, other radio waves 4 escape the hollow shaft 26. Because the radio waves 4, which escape the hollow shaft 26, are propagating in a substantially vertical direction, they will not be detectable by remote or distant ground-based antennas collecting data from data collection units 25. FIG. 1 illustrates a utility meter 1, such as a water meter 35, positioned underground in a pit 32. The meter 1 communicates by radio transmissions, but only very little of the energy emitted actually escapes the pit 32, and the part that does is transmitted in a disadvantageous direction, in this case directly upwards.

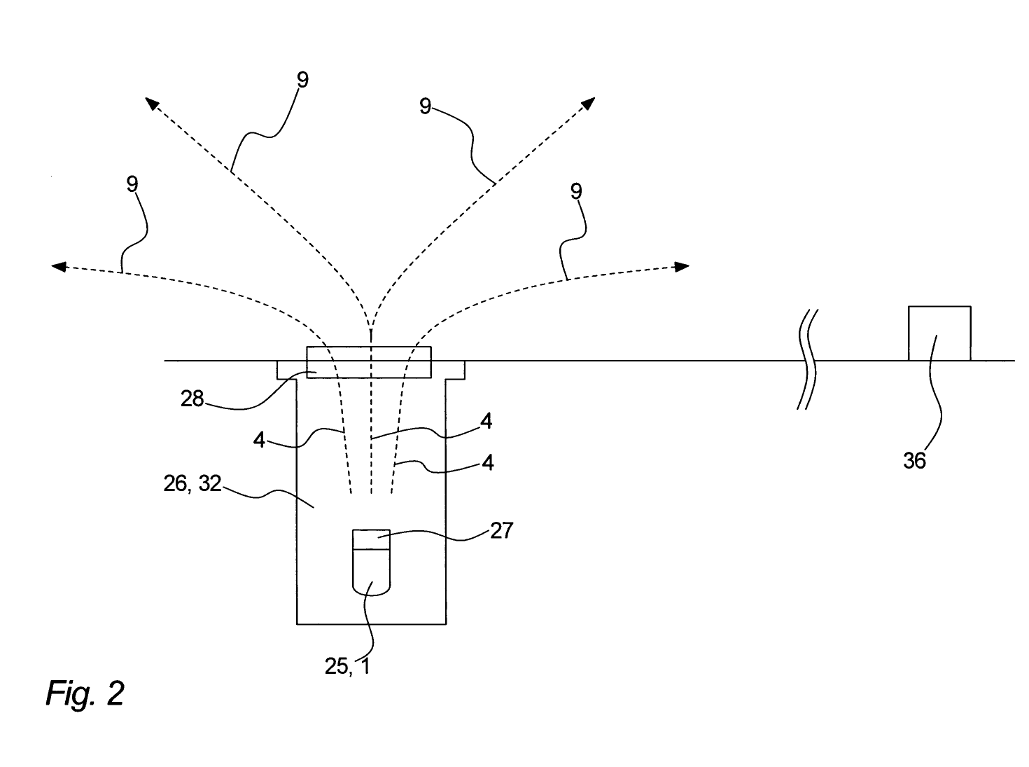

Referring to FIG. 2, a redirection device 28 is illustrated according to an embodiment of the invention. According to this embodiment, a data collection unit 25, such as a utility meter 1, is positioned in the bottom of a hollow shaft 26, such as a meter pit 32, while the redirection device 28 is placed in the top of said hollow shaft 26. The data collection unit 25 is connected to a radio emitter 27, which is adapted for transmitting or emitting a radio signal. On FIG. 2 such a radio signal is illustrated by radio waves 4, which are emitted by said radio emitter 27. When reaching the redirection device 28 in the top of the hollow shaft 26, the radio waves 4 are redirected, i.e. their direction of propagation is changed. This is illustrated by redirection radio waves 9. By redirecting the radio waves 4 their direction of propagation is altered. As it can be seen on FIG. 2, this preferable means that the primarily vertically propagating radio waves 4 are redirected to a more horizontal direction as is illustrated by the redirected radio waves 9. Thereby the communication range of the utility meter 1 is extended, and the redirected radio waves 9 may reach a communication device 36, such as a remote ground based radio signal receiving unit.

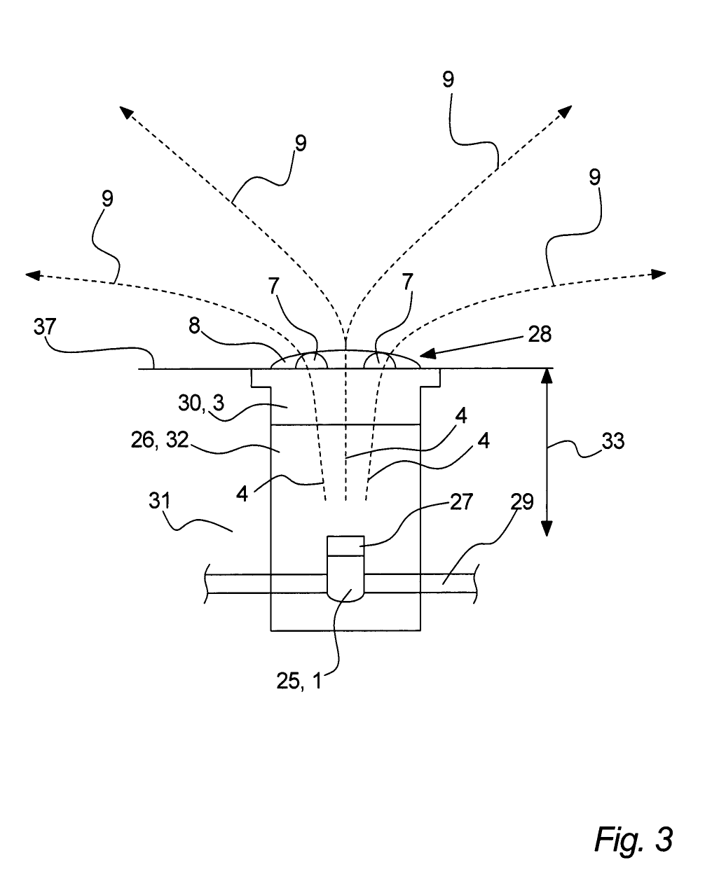

Referring to FIG. 3, a data collection unit 25 being a e.g. utility meter 1, such as a water meter 35, is illustrated according to a further embodiment of the invention. The utility meter 1 comprises a radio emitter 27, and is positioned underground in the lower part of a hollow shaft 26, being e.g. a meter pit 32 and is connected to a part of a utility system 29. This embodiment illustrates further to the embodiment illustrated on FIG. 2, a redirection device 28 comprising dielectric lenses 7 positioned in the top of the meter pit 32. Thereby, the utility meter 1 comprising the radio interface 27 is separated from the redirection device 28 by a distance 33. This distance 33 is, according to the embodiment illustrated in FIG. 3, significant compared to the depth of the meter pit 32, preferably at least half of this depth. The utility meter 1 transmits or emits radio waves 4, which are redirected by the redirection device 28, and which then propagate as redirected radio waves 9 in a more horizontal direction. Thereby, the communication range of the utility meter 1 is extended. In other words, FIG. 3 illustrates a utility meter 1, such as a water meter 35, positioned underground in a pit 32. In order to extend the communication range, a passive dielectric lens 7 is placed on top of the lid 3 on the meter pit 32.

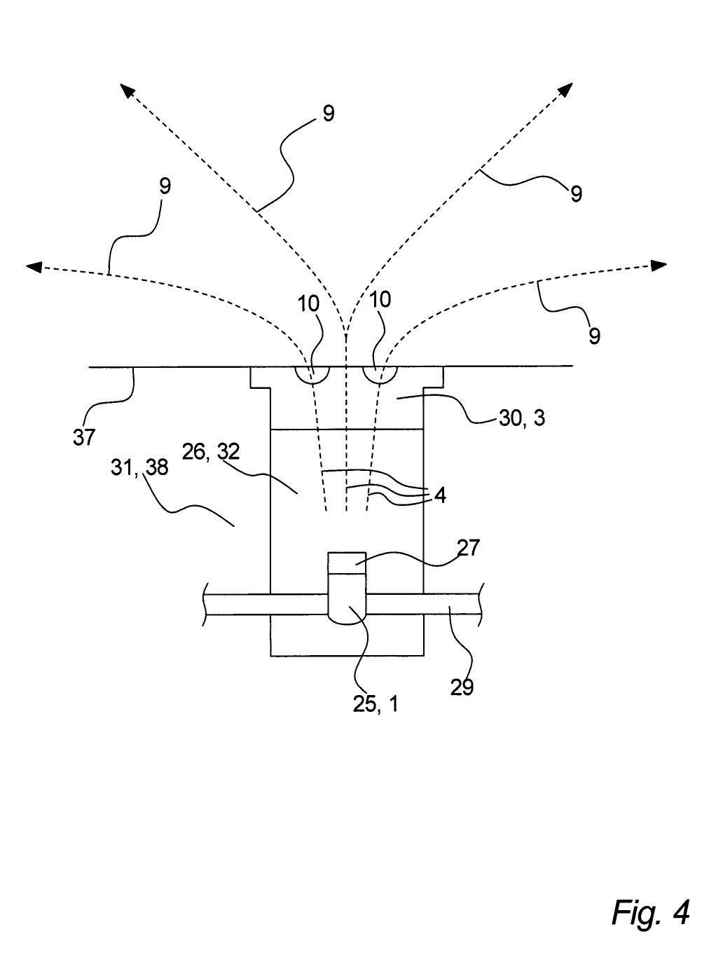

On FIG. 4 another embodiment of the invention is illustrated. Further to the embodiment illustrated on FIG. 2, the redirection device 28 comprises lid-embedded dielectric lenses 10. As can be seen from FIG. 4, these lenses 10 are integrated or embedded in the closing part 30, i.e. the lid 3, of the meter pit 32. Also, the utility meter 1 is connected to a part of a utility system 29 and performs measurements on this part 29, such as measuring the consumption of e.g. water, electricity, or heat. Also, the ground level 37 is illustrated indicating that the solid surroundings 31 are the ground 38. The utility meter 1 emits radio waves 4, which are redirected by the dielectric lenses 10 of the redirection device 28, and which then propagate as redirected radio waves 9 in a more horizontal direction. Thereby, the communication range of the utility meter is extended. In other words, FIG. 4 illustrates a utility meter 1, such as a water meter 35, positioned underground in a pit 32. In order to extend the communication range, a passive dielectric lens 10 is embedded inside the lid 3 on the meter pit 32.

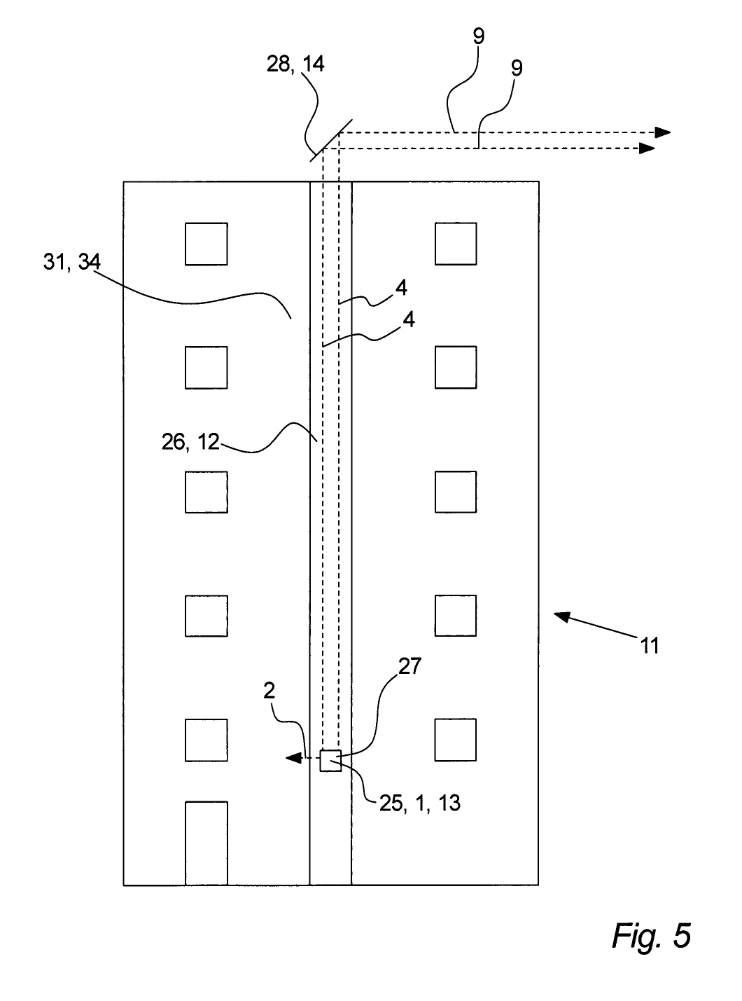

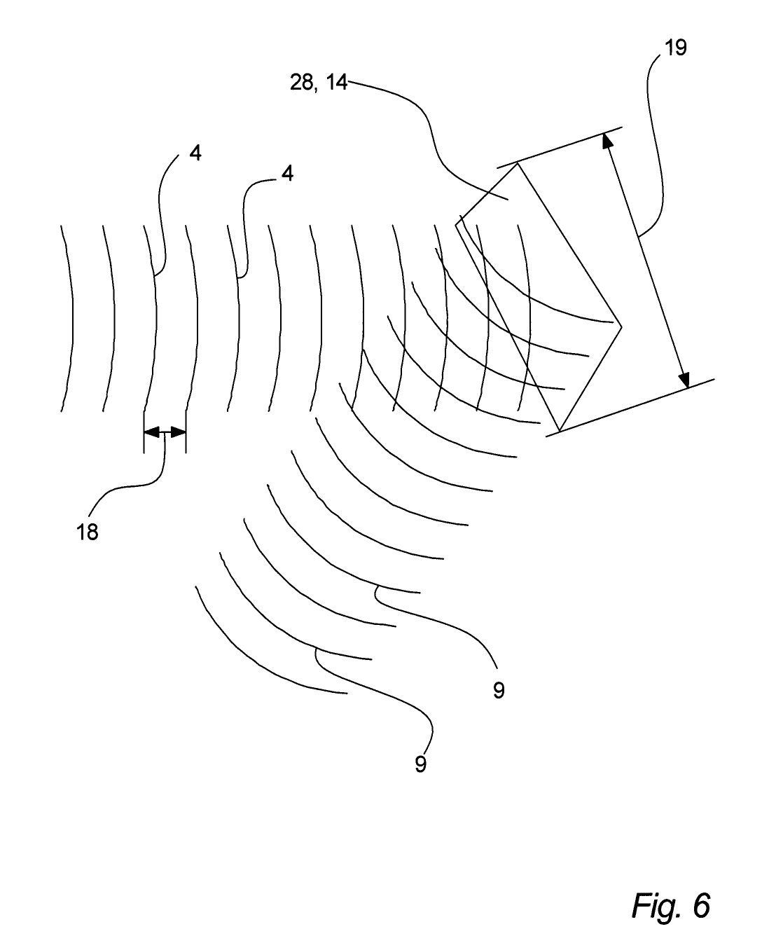

Referring to FIG. 5 a redirection device 28, such as a reflecting metal plate 14, implemented in a building 11 according to an embodiment of the invention is shown. The building 11 may e.g. be a tall multi-floor building 11. Furthermore, the building 11 comprises a hollow utility shaft 12. A data collection unit 25 such as a utility meter 1 is positioned in the utility shaft 12, preferably in the lower part of said utility shaft 12. Alternatively, the utility meter 1 may be positioned in other parts of the utility shaft 12, however, substantially into the utility shaft 12, such as at least 1 or 2 meters into the utility shaft 12. Furthermore, as can be seen on FIG. 5, a redirection device 28 is positioned on the top of the utility shaft 12. The utility meter 1 measures a parameter, preferably a consumption of a utility, such as water, electricity, gas, heat or other utilities, and emits a radio signal in the form of radio waves 4 on the basis of the measured parameter. The redirection device 28 redirects the radio waves 4, and the redirected radio waves 9 then propagate in a substantially horizontal direction, or at least in a more horizontal direction. If the radio emitter 27 emits radio waves 2 in other directions, such as horizontally, such radio waves 2 will be absorbed or attenuated by the solid surrounding 31 of the building material 34, which makes up the building 11. Therefore, by emitting radio waves 4 through the utility shaft 12, and then redirecting them at the top of the utility shaft 12 by a redirecting device 28, the communication range of the radio emitter 27 and thereby the utility meter 1 is greatly improved. In a preferred embodiment the radio waves 4 from the utility meter 1 are directed towards a remote communication device 36, such as a ground based radio signal receiving unit.

According to another embodiment, FIG. 5 illustrates a tall building 11 with several utility meters 13 inside. The utility shaft meters 13 are positioned in a utility shaft 12 deep inside the building 11. On top of the building 11 a device 28 for redirection of radio transmission signals is placed, so that signals 4 from the utility meters 13 are directed towards a communications device 36.

On FIG. 6 another embodiment of the invention is illustrated. Here, radio waves 4 are being redirected by a metal plate 14. A redirection device 28 in the form of a metal plate 14 is shown. Radio waves 4 are incident on the metal plate 14. These radio waves 4 have a certain wavelength 18. The metal plate 14 has a length 19, which is longer than the wavelength 18 of the radio waves 4. Thereby, the metal plate 14 will reflect and therefore redirect the radio waves 4. The redirected radio waves 9 will propagate in a direction determined by the orientation of the metal plate 14 and the direction of propagation of the incident radio waves 4.

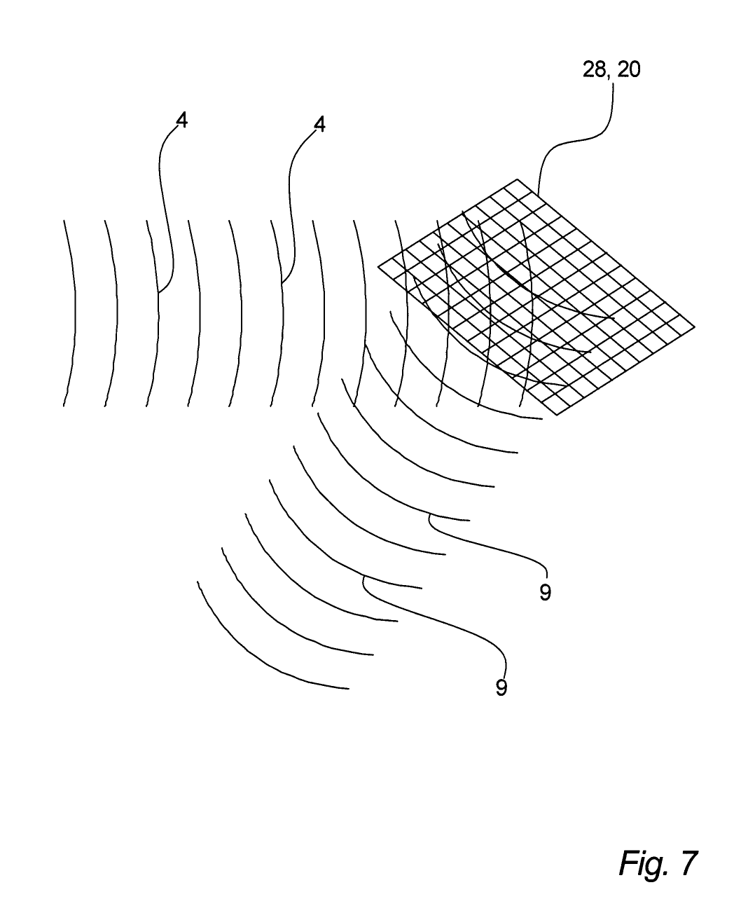

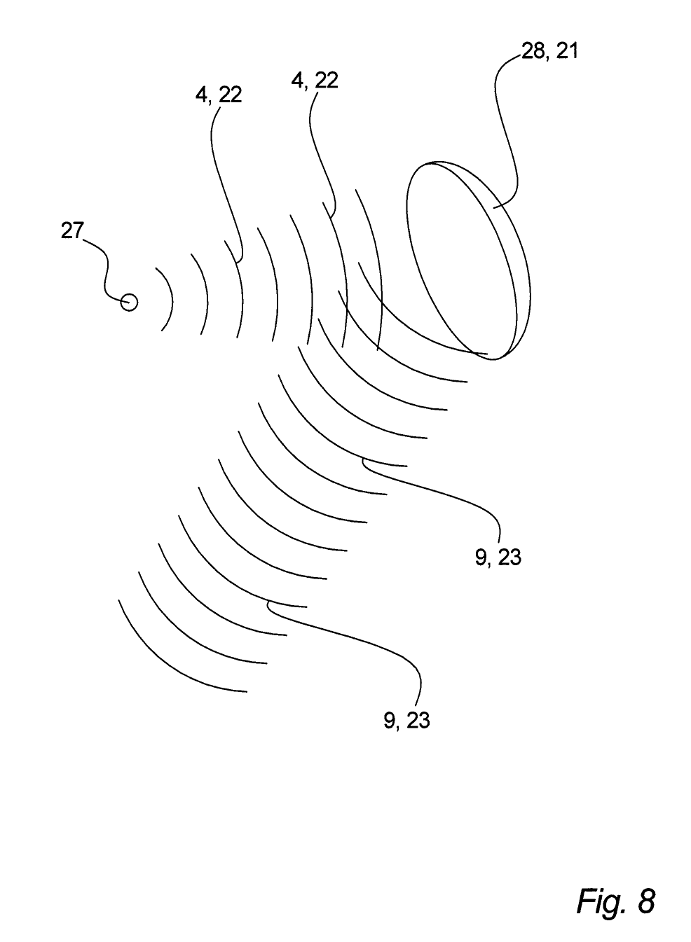

Referring to FIG. 7 is a redirection device 28 according to an embodiment of the invention. Here, radio waves 4 are being redirected by a metal plate 14 in the form of a mesh 20. I.e. the redirection device 28 is made up by a metallic mesh 20. This mesh 20 is redirects the incident radio waves 4. The redirected radio waves 9 will propagate in a direction determined by the orientation of the metal plate 14 and the direction of propagation of the incident radio waves 4.

Referring to FIG. 8 is a redirection device 28 according to an embodiment of the invention. Here, diverging radio waves 22 are being redirected by a curved metal plate 21 so that the waves reflected from the plate 21 are focused. The redirection device 28 is a curved metal plate or disc 21. A radio emitter 27 emits radio waves 4. The emitted radio waves 4 are in this embodiment diverging radio waves 22. Therefore, the signal strength of the diverging radio waves 22 decreases as the distance to the radio emitter 27 increases. The redirection device 28 reflects and thereby redirects the diverging radio waves 22. Furthermore, since the redirection device 28 is a curved disc 21, it has a focusing effect on the redirected radio waves 9. Thereby, the redirected radio waves 9 may be collimated or focused radio waves 23. The redirected radio waves 9 will propagate in a direction determined by the orientation of the metal plate 21 and the direction of propagation of the incident diverging radio waves 22. Preferably, the shape, position, and orientation of the metal disc 21 are such that the focal point of the redirected radio waves 9 corresponds to the position of the remote communication device 36, such as a ground based radio signal receiving unit, if such a specific intended recipient exists.

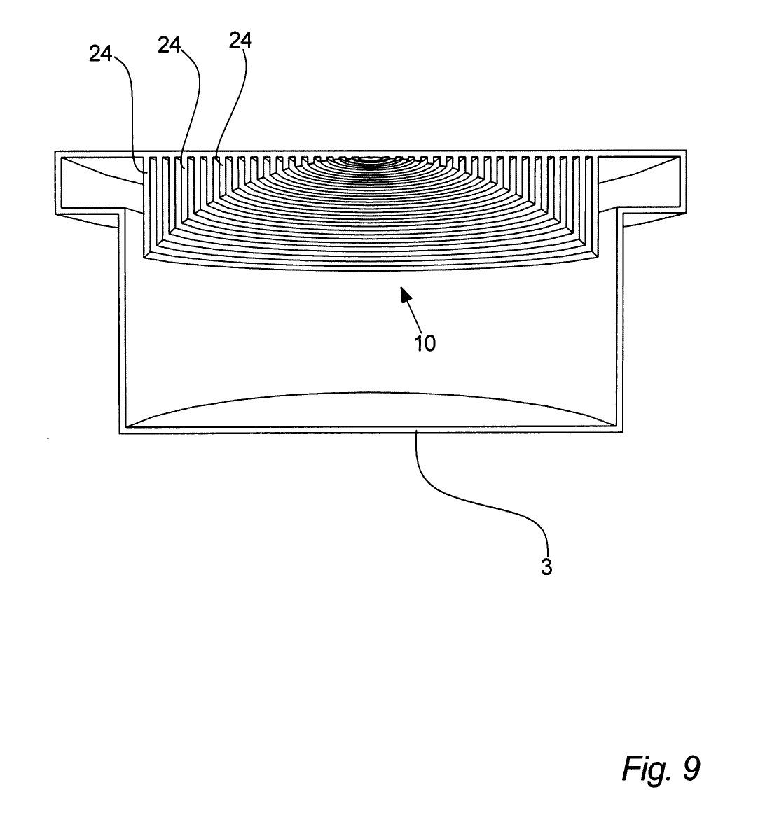

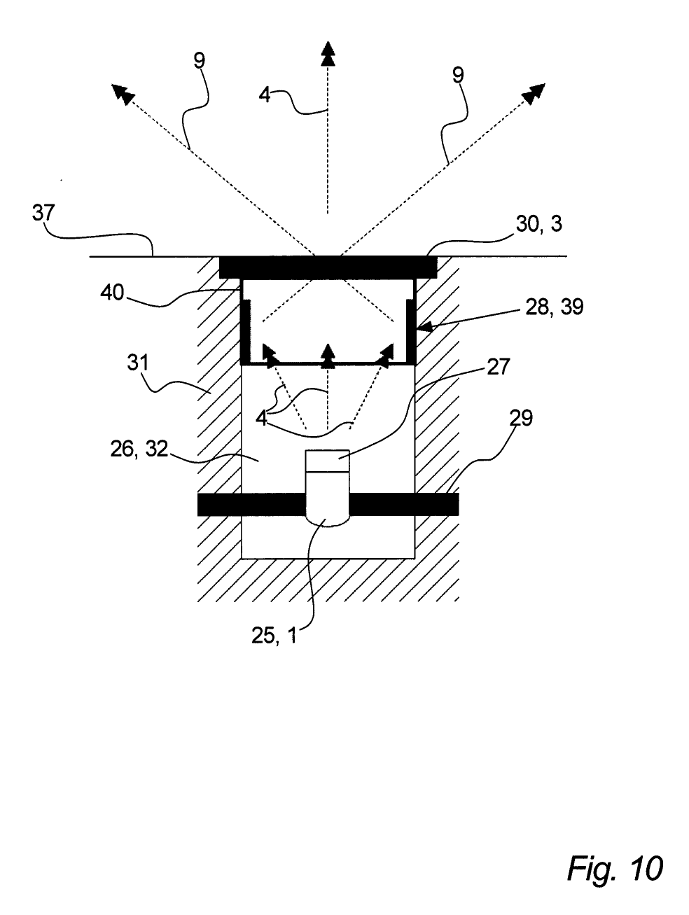

On FIG. 9, a cut-through view of a closing part 30, such as a lid 3, is illustrated according to an embodiment of the invention. The lid 3 comprises a lid-embedded dielectric lens 10. This dielectric lens 10 comprises a number of concentric cylinders 24. These concentric cylinders 24 are preferably of different lengths. Furthermore, the thickness of the material is substantially constant, so that manufacturing is optimized. In other words, FIG. 9 illustrates a cut-through of a lid 3 for a meter pit 32, with an embedded dielectric lens 10. The thickness of the material is substantially constant, so that manufacturing is optimized. In this case, the lens 10 consists of several concentric cylinders 24 of different lengths.

Referring to FIG. 10 another embodiment of the invention is illustrated. A covering part 30, such as a lid 3, covers the top part of a hollow shaft 26, such as a meter pit 32. In the meter pit 32 a data collection unit 25, such as a utility meter 1, is placed.

More specifically, the meter 1 is connected to a part 29 of a utility system, said part 29 of the utility system passing through the meter pit 32. Since the part 29 of the utility system passes through the bottom part of the meter pit 32, the meter 1 is placed in the bottom part of the meter pit 21. The meter 1 is connected to a radio emitter 27, preferably such that the radio emitter 27 is integrated in the meter 1. The lid 3 comprises a connecting part 40 and a redirection device 28, the redirection device 28 being a metal cylinder 39. The connecting part 40 connects the metal cylinder 39 with the covering part of the lid 3, i.e. with the upper part of the lid 3. The radio emitter 27 emits radio waves 4. Some of these radio waves 4 propagate vertically or at least nearly vertically, such that they will not interact with the metal cylinder 39. However, other radio waves 4 propagate onto the metal cylinder 39, which redirects them, so that they propagate onwards in another direction as redirected radio waves 9. This other direction of propagation of the redirected radio waves 9 is more horizontal compared to the radio waves 4 before redirection. Thereby, the horizontal range of the emitted radio waves 4 is increased, i.e. the communication range of the meter 1 is increased. The metal cylinder 39 redirects the radio waves by means of reflection, or, alternative, by means of diffraction, or by means of a combination of reflection and diffraction.

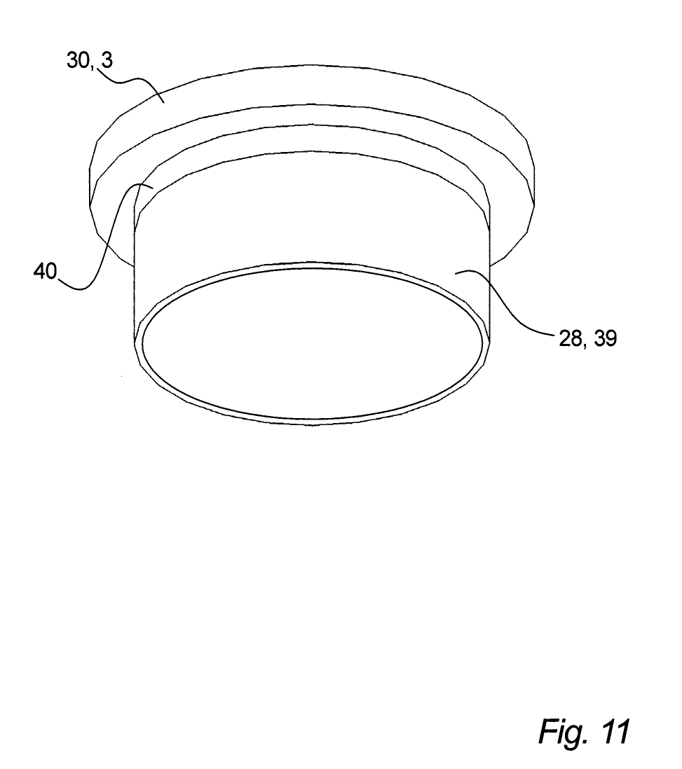

On FIG. 11, a perspective view of the lid comprising a redirecting device according to the above embodiment is illustrated. Here it may also be observed that the connecting part 40 connects the upper or covering part of the lid 3 with a metal cylinder 39. The metal cylinder acts as a redirection device 28. The metal cylinder may in some embodiments be a thin metal foil, and may e.g. be 30 centimeters in height. Experiments have shown that a metal foil of aluminum, i.e. an aluminum foil, is effective in redirecting a radio wave signal at 868 MHz. Such an aluminum foil may e.g. be between 0.01 mm and 0.7 mm in thickness. It is also possible to use other metals, such as iron, copper, tin, lead, silver or gold, or mixtures of these. Furthermore, foils may be used as described above, but also thicker layers of metal, such as 0.5 mm to 2 mm, or between 1 mm and 1 cm, or even thicker layers of 1 cm to 10 cm.

### REFERENCE NUMERALS

1. Utility meter

2. Radio waves attenuated in ground

3. Lid

4. Radio waves

7. Dielectric lens

8. Cover for dielectric lens

9. Redirected radio waves

10. Lid-embedded dielectric lens

11. Building

12. Utility shaft

13. Utility shaft meters

14. Metal plate

18. Wavelength of radio waves

19. Length of metal plate

20. Metal mesh

21. Curved metal plate

22. Diverging radio waves

23. Focused radio waves

24. Concentric cylinders

25. Data collection unit

26. Hollow shaft

27. Radio emitter

28. Redirection device

29. Part of utility system

30. Closing part of hollow shaft

31. Solid surroundings

32. Meter pit

33. Physical distance

34. Building material

35. Water meter

36. Communication device

37. Ground level

38. Ground

39. Metal cylinder

40. Connecting part

1. A method of transmitting and redirecting a radio signal via a data transmission system,
wherein said data transmission system comprises
a data collection unit,
a radio transmitter connected to said data collection unit, and
a redirection device arranged at the top of a hollow shaft,
wherein said radio transmitter and said data collection unit are arranged in a lower part of said hollow shaft,
and wherein said method comprises the steps of
transmitting, by said radio transmitter, said radio signal representative of measurement data from said data collection unit, and
redirecting, by said redirection device, said radio signal to be received at a communication device.

2. The method of transmitting and redirecting a radio signal via a data transmission system according to claim 1, wherein said radio transmitter comprises a radio wave emitter adapted for emitting radio waves.

3. The method of transmitting and redirecting a radio signal via a data transmission system according to claim 1, wherein said data collection unit is a utility meter.

4. The method of transmitting and redirecting a radio signal via a data transmission system according to claim 1, wherein said measurement data comprises measured consumption data.

5. The method of transmitting and redirecting a radio signal via a data transmission system according to claim 1, wherein said hollow shaft is a meter pit.

6. The method of transmitting and redirecting a radio signal via a data transmission system according to claim 1, wherein said hollow shaft is a utility shaft.

7. The method of transmitting and redirecting a radio signal via a data transmission system according to claim 1, wherein said method further comprises the step of
receiving, by said radio transmitter, measurement data from said data collection unit.

8. The method of transmitting and redirecting a radio signal via a data transmission system according to claim 1, wherein said data collection unit and said redirection device are separated by a distance corresponding to at least half the vertical distance of said hollow shaft.

9. The method of transmitting and redirecting a radio signal via a data transmission system according to claim 1, wherein said radio transmitter is integrated in data collection unit.

10. The method of transmitting and redirecting a radio signal via a data transmission system according to claim 1, wherein said redirection device comprises a metal cylinder.

11. The method of transmitting and redirecting a radio signal via a data transmission system according to claim 1, wherein said redirection device comprises at least one metallic plate.

12. The method of transmitting and redirecting a radio signal via a data transmission system according to claim 11, wherein said at least one metallic plate of said redirection device has at least one length that is longer than the wavelength of the radio transmission signals.

13. The method of transmitting and redirecting a radio signal via a data transmission system according to claim 11, wherein said at least one metallic plate of said redirection device is curved.

14. The method of transmitting and redirecting a radio signal via a data transmission system according to claim 1, wherein said redirection device comprises at least one metallic mesh.

15. The method of transmitting and redirecting a radio signal via a data transmission system according to claim 1, wherein said redirection device comprises at least one Fresnel lens.

16. The method of transmitting and redirecting a radio signal via a data transmission system according to claim 1, wherein said redirection device comprises at least one component which comprises a metamaterial.

17. The method of transmitting and redirecting a radio signal via a data transmission system according to claim 1, wherein said redirection device comprises at least one dielectric lens.

18. A data transmission system for transmitting and redirecting a radio signal,
wherein said data transmission system comprises
a data collection unit,
a radio transmitter connected to said data collection unit, and
a passive redirection device arranged at the top of a hollow shaft,
wherein said radio transmitter and said data collection unit are arranged in a lower part of said hollow shaft,
wherein said radio transmitter is configured for transmitting said radio signal which is representative of measurement data from said data collection unit, and
wherein said redirection device is arranged for redirecting said radio signal to be received at a communication device.

19. (canceled)

20. A redirection device for redirecting a radio signal from a radio transmitter positioned in a lower part of a hollow shaft, wherein said redirection device, when positioned at the top of the hollow shaft, is adapted for redirecting a radio signal from said radio transmitter.

21. (canceled)
